(19) United States
(12) Patent Application Publication
(10) Pub. No.: US 2017/0163737 A1
(43) Pub. Date: Jun. 8, 2017

(54) WIRELESS STATION AND METHOD FOR MANAGING A MULTI-BAND SESSION IN WI-FI DIRECT SERVICES

(71) Applicant: Intel IP Corporation, Santa Clara, CA (US)

(72) Inventors: Carlos Cordeiro, Portland, OR (US); Bahareh Sadeghi, Portland, OR (US); Emily H. Qi, Gig Harbor, WA (US)

(21) Appl. No.: 15/439,629

(22) Filed: Feb. 22, 2017

Related U.S. Application Data
(63) Continuation of application No. 14/089,374, filed on Nov. 25, 2013.
(60) Provisional application No. 61/824,028, filed on May 16, 2013.

(51) Int. Cl. H04L 29/08; H04B 1/00; H04W 76/04; H04L 29/06; H04W 4/00

(52) U.S. Cl. CPC H04L 67/141; H04L 69/14; H04W 4/008; H04W 76/043; H04L 67/104; H04B 1/005; H04W 84/12

(57) ABSTRACT

Embodiments of a method for managing a multi-band Wi-Fi Direct Services session are generally described herein. In some embodiments, the method negotiates the session with a wireless communication station over a first frequency hand. The negotiation includes transmitting application programming interface (API) parameters to the wireless communication station that includes parameters for a second frequency band and a channel associated with the second frequency band.

### PRIORITY CLAIM

This application is a continuation of U.S. patent application Ser. No. 14/089,374, tiled Nov. 25, 2013, which claims the benefit of priority under 35 U.S.C. 119(e) to U.S. Provisional Patent Application Ser. No. 61/824,028, filed on May 16, 2013, each of which is incorporated herein by reference in its entirety.

### TECHNICAL FIELD

Some embodiments relate to wireless networks. Some embodiments relate to Wi-Fi networks.

### BACKGROUND

IEEE 802.11 is a set of standards for implementing wireless local area network (WLAN) communications. These standards provide the basis for wireless network equipment approved and certified as Wi-Fi equipment.

Wi-Fi. networks may use access points to wirelessly communicate with either mobile communication devices (e.g., smart phones, computers, tablet computers). The access points can be connected to a wired network giving the access point access to the Internet. The mobile communication device can then access the Internet through communication with the access point.

Wi-Fi Direct may provide peer-to-peer connectivity to allow users to connect their wireless devices in order to share, show, print, and/or synchronize content with other wireless devices. For example, Wi-Fi Direct might enable a. computer, communicating with a Wi-Fi protocol, to communicate directly with a mobile telephone (e.g., cellular mobile telephone) without the need to go through an access point.

Wi-Fi Direct, however, may only provide link layer connectivity. This limited connectivity may not be enough to enable interoperability between applications from multiple vendors. Thus, an application from a first vendor, on a first wireless device, may not be able to communicate with an application from a. second vendor, on second wireless device. While a common set of application programming interfaces (APIs) have been developed to improve the interoperability, the data exchange may only take place over the same frequency band that was used to establish a Wi-Fi Direct Services session.

Thus there are general needs for improved Wi-Fi Direct services. There are also general needs for improved Wi-Fi Direct data exchange.

### BRIEF DESCRIPTION OF THE DRAWINGS

FIG. 1 illustrates a block diagram of various network elements of a wireless network in accordance with some embodiments.

FIG. 2 illustrates a functional diagram of a wireless communication station in accordance with some embodiments.

FIG. 3 illustrates a block diagram of the various network elements of FIG. 1 in accordance with an embodiment for Wi-Fi Direct Services session establishment.

FIG. 4 illustrates a Wi-Fi Direct Services protocol architecture in accordance with some embodiments.

FIGS. 5A and 5B illustrate flowcharts of methods for a multi-band Wi-Fi Direct Services session in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

As used subsequently, services may refer to applications (e.g., software, firmware) that may be executed by processing circuitry of wireless communication stations. For example, services may refer to client software such as World Wide Web browsers, print routines, media display/play applications, gaming applications, and other software applications.

Also as used subsequently, a session may refer to an established communication link between two or more wireless communication stations. In another embodiment, a session may include the frame exchange used to build the link between the two or more wireless communication stations, the actual service data exchange between the two or more wireless communication stations, as well as the frame exchange to break the link between the two or more wireless communication stations.

A Wi-Fi Direct Services common set of APIs and protocols have been developed to enable inter-services inter-application) operability. As described subsequently, an Application Service Platform (ASP) in each wireless communication station is a logical entity that may implement common functions used by application services (e.g., play, send, display, print). Within the ASP, different protocol elements may be defined to realize wireless communication station discovery, service discovery, topology management, and session management.

As recited by the current Wi-Fi Direct Services specification, it is assumed that the service data (i.e., data exchanged between services/applications once a session is established) may only be exchanged over the same frequency band in which the session was established. However, by not limiting the frequency band over which service data is exchanged, the radio resources of multi-band wireless communication stations may be better used to provide improved power and performance during the service data exchange and, thus, and enhanced user experience.

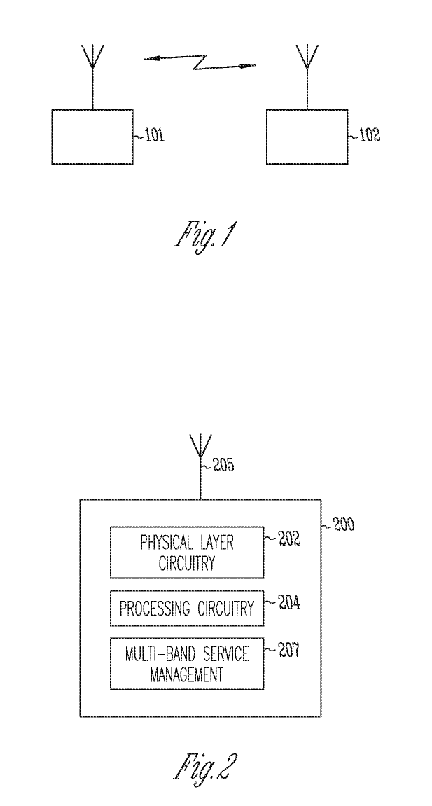

FIG. 1 illustrates various network elements of a wireless communication network (e.g., Wi-Fi network) in accordance with some embodiments. The wireless communication network includes a plurality of wireless communication stations 101-102 that may communicate over one or more wireless channels in accordance with IEEE 802.11 communication protocols (e.g., IEEE 802.11a/b/g/n/ac/ad including the IEEE 802.11-2012 communication standards).

The wireless communication stations 101-102 may include wireless clients, wireless computing devices, wireless printers, and/or other wireless devices with the ability to communicate over the wireless communication network. Examples of wireless computing devices 101-102 may include smart telephones, tablet computers, lap top computers, or other computing devices that have the ability^{,} to communicate over one or more wireless channels using one or more communication protocols (e.g., IEEE 802.11). The wireless communication stations 101-102 may include either mobile or stationary communication stations.

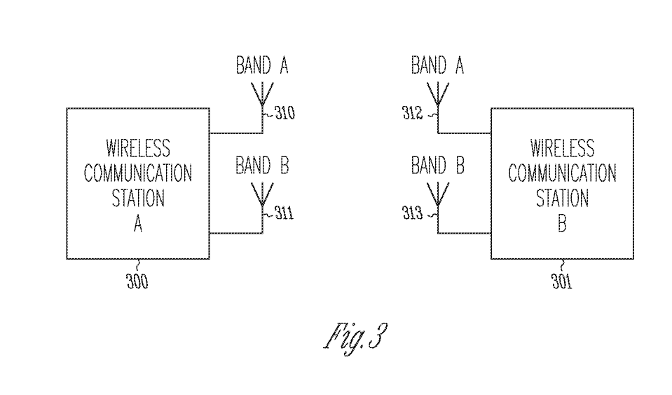

FIG. 2 is a functional diagram of a wireless communication station 200 in accordance with some embodiments. The wireless communication station 200 may be suitable for use as one or more of the wireless communication stations 101-102 (FIG. 1), although other configurations may also be suitable.

Wireless communication station 200 may include physical layer circuitry 202 to communicate wirelessly with access points, mobile communication devices, and other communication stations over an antenna 205. Wireless communication station 200 may also include processing circuitry 204 coupled to the physical layer circuitry 202 to perform other operations described herein. Wireless communication station 200 may also include a multi-band management block 207 that may be configured to manage the switching between different frequency bands and/or antennas during a multi-band session. In another embodiment, the multi-band management block 207 may be part of the physical layer circuitry 202.

In accordance with embodiments, the physical layer circuitry 202 may include the radio circuitry configured to establish a communication session between wireless communication stations and transmit and receive data frames between the wireless communication stations once the session has been established. The physical layer circuitry 202 may also be configured to transmit and receive acknowledgments as well as other communications between wireless communication stations. A communication session may also be handled by a media access control (MAC) function processing block.

In accordance with embodiments, the processing circuitry 204 may be configured to control execution of any processes of the wireless communication station in establishing and maintaining a multi-band Wi-Fi Direct Services with one or more other wireless communication stations, The processing circuitry 204 may also be configured to control execution of other multi-band Wi-Fi Direct process, such as those disclosed herein. The processing circuitry 204 may include memory and an application processor to process API's as disclosed herein.

Although wireless communication station 200 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of wireless communication station 200 may refer to one or more processes operating on one or more processing elements.

In some embodiments, a wireless communication station 200 may be part of a portable wireless communication device, such as a personal digital assistant (PDA), a laptop or portable computer with wireless communication capability, an Ultrabook™, a tablet computer, a wireless telephone, a smartphone, a wireless headset, a pager, an instant messaging device, a digital camera, an access point, a television, a medical device (e.g., a heart rate monitor, a blood pressure monitor, etc.), or any other device that may receive and/or transmit information wirelessly. In some embodiments, the wireless communication station may include one or more of a keyboard, a display, a non-volatile memory port, multiple antennas, a graphics processor, an application processor, speakers, and other mobile device elements, The display may be an LCD or LED (e.g., organic light emitting diode) screen, including a touch screen.

FIG. 3 illustrates a block diagram of the various network elements of FIG. 1 in accordance with an embodiment for multi-band Wi-Fi Direct Services establishment. This figure illustrates two wireless communication stations 300, 301 that may each be capable of multi-band communication,

IEEE 802.11 currently supports multiple frequency bands. For example, one or more of the IEEE 802.11 specifications currently support 2.4 GHz, 5 GHz, and 60GHz frequency bands. Each non-overlapping frequency band may be assigned a plurality of non-overlapping channels. These frequency bands are for purposes of illustration only as the present embodiments are not limited to any particular frequency bands.

As is known in the art, different frequency bands have different properties that may provide different benefits for different uses and channel conditions, For example, lower frequency bands may provide reduced bandwidth for data transmission but may provide longer transmission range. Higher frequency bands may provide higher bandwidth for data transmission but the transmission range of these higher frequency bands may be reduced as compared to the lower frequency bands.

A multi-band Wi-Fi Direct Services session method may take advantage of the different properties of the different frequency bands. For example, two wireless communication stations may establish a Wi-Fi Direct Services on a first frequency band but then transmit/receive service data over a different frequency band as determined by the channel conditions, maximum error rate tolerated, and/or transmission speed desired for the data.

For purposes of illustration only, the wireless communication stations 300, 301 are each shown with multiple antennas 310-313. Each antenna may represent a different frequency band used by that particular wireless communication station 300, 301. Other embodiments may use only a single antenna for transmission and reception of data over multiple frequency bands.

The number of frequency bands available in each wireless communication station may also be different than the two e.g., A and B) illustrated in FIG. 3. For example, to implement 2.4 GHz, 5 GHz, and 60 GHz Wi-Fi Direct Services sessions, each wireless communication station may be capable of communicating over three or more frequency bands, each frequency band having an assigned quantity of non-overlapping channels.

The method for multi-band Wi-Fi Direct Services session management may enable switching multiple times, during a single session, between different frequency bands. For example, a session may be negotiated over frequency band A but then switch to frequency band B in response to an executed service. During the same session, the frequency band may be switched back to frequency band A or to another frequency band without closing the present session or starting a new session. An embodiment for switching frequency bands using parameters of Application Programming interfaces (APIs) is discussed subsequently.

As an example of operation of an embodiment of the multi-band Wi-Fi Direct Services session method, wireless communication station A 300 may establish a Wi-Fi Direct Services session with wireless communication station B 301 over frequency band A using antennas 310, 312. Wireless communication station A 300 may be executing a service that uses a relatively large amount of data (e.g., displaying an image) from wireless communication station B 301. Such a service may benefit from using a higher frequency band (e.g., higher available bandwidth) than the frequency band used to establish the Wi-Fi Direct Services session. Either wireless communication station A 300 or wireless communication station B 301 may then request that the session switch from the frequency band used to establish the session (e.g., frequency band A) to a higher frequency band (e.g., frequency band B), for the higher data transmission bandwidth, using antennas 311, 313.

In another embodiment (i.e., during the same session or a different session), wireless communication station B 301 may be executing a service (e.g., World Wide Web browsing) that uses only a relatively low data rate in communication with wireless communication station A 300. Either wireless communication station A 300 or wireless communication station B 301 may request that the session switch from its present frequency band (e.g., band B) to another frequency band (e.g., band A, lower frequency band) than the frequency band currently being used by the session. The relatively lower frequency band may provide a lower data error rate and longer transmission distance than the previous higher frequency band. In another embodiment, the session may remain on the same frequency band as that used either to establish the session or is currently being used for the session.

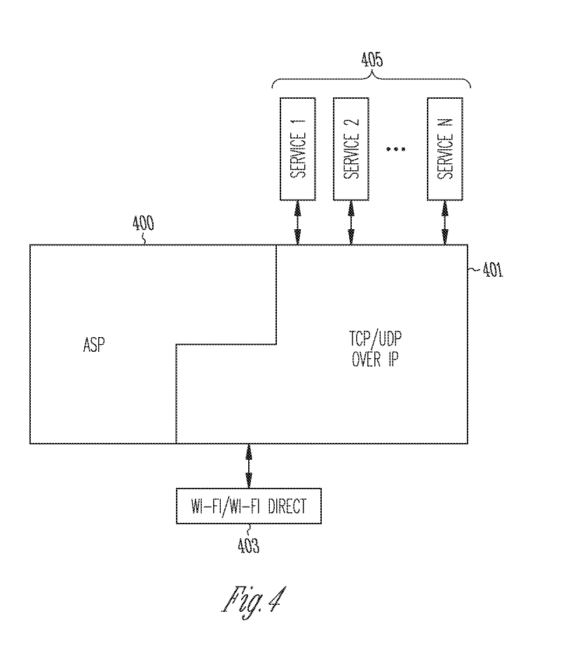

FIG. 4 illustrates a Wi-Fi Direct services protocol architecture that may be present in one or more wireless communication stations that are part of a multi-band Wi-Fi Direct service session. The protocol architecture is for purposes of illustration only as one or more of the wireless communication stations may have different architectures.

The architecture may include a Wi-Fi/Wi-Fi Direct link 403 that may be the IEEE 802.11 network channel between the Wi-Fi/Wi-Fi Direct wireless communication stations. This link 403 may be at different frequency bands as determined in response to the services 405 being executed.

The N services 405 may include various applications that may be executed by the wireless communication station. These services may include print routines, image display routines, World Wide Web browsing applications, gaming, or other software/applications.

An Application Service Platform (ASP) is the logical entity that may implement the common functions used by services 405. Each of the wireless communication stations in a multi-band Wi-Fi Direct Services session may have an ASP since each may use the ASP to execute their own respective services and also to respond to a service being executed by another wireless communication stations in the session.

A Transmission Control Protocol/User Datagram Protocol (TCP/LDP) over Internet Protocol (IP) block 401 may be used to enable communication between the services 405 and the WI-Fi/Wi-Fi Direct link 403 using IP. As is known in the art, TCP/UDP are protocols for connecting and assigning ports for data communication over the Internet. These protocols may bind a particular service 405 to a particular TCP or UDP port for communication during a multi-band Wi-Fi Direct Services session.

An embodiment of the method for multi-band session in Wi-Fi Direct services may use APIs to change the wireless communication station's currently used frequency band to another frequency band. This embodiment is for purposes of illustration only as other ways can be used for switching frequency bands in a wireless communication station.

As is known in the art, an API may be a source code based library that includes specifications for routines, object classes, or variables, The API may also be executable code and/or object code. The API may specify a set of functions or routines that accomplish a specific task or interact with a specific software component.

An API format may include an API name that may represent a function. The API may also include a list of parameters associated with that particular function that may be passed with the API to the other one or more wireless communication stations. An example of an API and its associated parameters (e.g., API parameters) may include ConnectSessions(List of (service_mac, advertisement_id), session information, network_role, operating_class, channe_number, and MAC_address). This API may inform a receiving wireless communication station that another wireless communication station desires to set up a session. The list of parameters associated with this API then informs the receiving wireless communication station of the necessary information to set up a particular session.

For example, the “List of (service_MAC, advertisement_id)” parameter may inform the receiving wireless communication station of the Media Access Control (MAC) address and identification to be used to advertise the session. The “session_information” parameter may inform the receiving wireless communication station of various data used to describe the session. The “network_role” parameter may inform the receiving wireless communication station of its role in the session (e.g., group owner or client device). The “operating_class” parameter may inform the receiving wireless communication station of the frequency hand to be used once the session has been established. The “channel_number” parameter may inform the receiving wireless communication station of the channel number to be used within that particular frequency band. The “MAC_address” parameter may inform the receiving wireless communication station of the media access control address to be used within that particular frequency band since the communication station may have different MAC addresses on different frequency bands as well as different channels within each frequency band. In another embodiment, the MAC_address may be for each different channel number.

In an embodiment, the API parameters may be passed when the wireless communication stations are negotiating a session over a first band (e.g., band A). The API parameters may specify that, once the session is established over the first band, the actual service data may be transmitted over a second band (e.g., band B). Another embodiment may pass another API parameter during the session in order to change the frequency band for the service data during the session.

The Wi-Fi Direct Services (WFDS) specification currently has a number of APIs that may be used to enable a multi-band Wi-Fi Direct Services session. For example, the WFDS specification includes APIs such as ConfirmSessions( ), GetSession( ), SetSessionReady( ), CloseSession( ), BoundPort( ) and ReleasePort( ). Each of these APIs may have different associated parameters, depending on their respective function, and also include the operating class (e.g., frequency hand), channel number, and MAC address to enable multi-band operation during a Wi-Fi Direct Services session, These APIs are for purposes of illustration only as other APIs can include the parameters of operating class, channel number, and MAC address.

In addition to including the operating class, channel number, and MAC address in the parameters of the APIs, the events associated with the APIs may also incorporate these parameters. For example, events such as SessionRequest( ) ConnectStatus( ) SessionStatus( ) and PortStatus( ) may also include the operating class, channel number, and MAC address in the parameters. These events are for purposes of illustration only as other events can include the parameters of operating class, channel number, and MAC address.

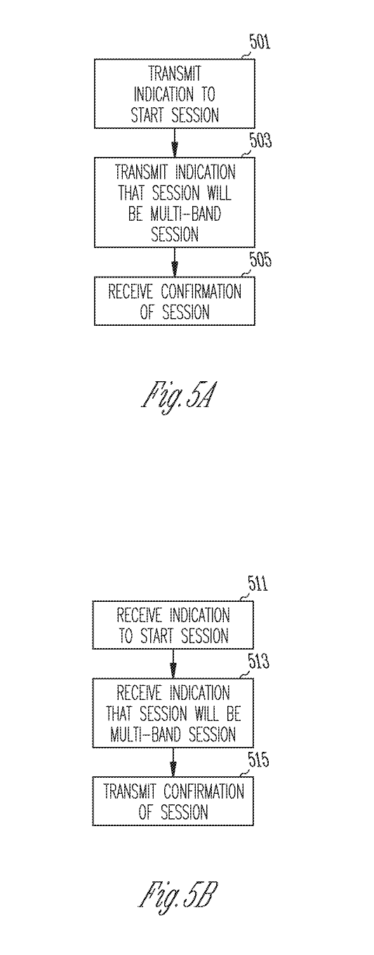

FIG. 5A illustrates a flowchart of an embodiment of a method for multi-band Wi-Fi Direct Services sessions as used by the wireless communication station initiating a session. The method may include the initiating wireless communication station negotiating a Wi-Fi Direct Services session with one or more wireless communication stations by transmitting an indication (e.g., API) 501 to these stations to start the session.

The initiating wireless communication station may transmit an indication to the receiving wireless communication station(s) that the session will be a multi-band Wi-Fi Direct Services session 503. In an embodiment, this indication may be included as API parameters that were transmitted to set up the session. In another embodiment, this indication may be transmitted separately to the receiving wireless communication station(s).

A confirmation may then be received 505 from the one or more wireless communication stations with which the initiating wireless communication station is attempting to start the session. The confirmation may be in the form of an API (e.g., ConfirmSession( ) ) that may include the parameters such as operating class, channel number, and MAC address, as discussed previously.

FIG. 5B illustrates a flowchart of an embodiment of a method for multi-band Wi-Fi Direct Services sessions as used by the one or more receiving wireless communication stations with which the initiating wireless communication station is negotiating a session. These wireless communication stations receive the indication (e.g., API parameter) to start the session 511.

The receiving wireless communication stations may also receive the indication that the session will be multi-band 513. The indication may be received as the parameters in an API, as discussed previously, or by some other indication. The one or more receiving stations may then transmit the confirmation of the session 515 to the initiating wireless communication station. This confirmation may be in the form of an API (e.g., ConfirmSession( )) that may include the parameters such as operating class, channel number, and MAC address, as discussed previously.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, a system may include one or more processors and may be configured with instructions stored on a computer-readable storage device.

### ADDITIONAL NOTES AND EXAMPLES

Example 1 is a method for managing a multi-band Wi-Fi Direct Services session that comprises negotiating a start of the session with a wireless communication station over a first frequency band, and transmitting an indication to the wireless communication station that service data during the session will be transmitted over a second frequency band.

In Example 2, the subject matter of Example 1 can optionally include transmitting the indication to the wireless communication station that service data during the session will be transmitted over the second frequency band comprises transmitting an application programming interface (API) having parameters referencing the second frequency band.

In Example 3, the subject matter of Example 2 can optionally include wherein the API is ConnectSessions( ).

In Example 4, the subject matter of Example 3 can optionally include wherein ConnectSessions( )omprises parameters operating_class, channel_number, and MAC address wherein operating_class is the second frequency band, channel_number is a channel within the second frequency band, and MAC_address is a media access control (MAC) address associated with the second frequency band.

In Example 5, the subject matter of claim 1 can optionally include receiving, from the wireless communication station, a confirmation of the session being established.

In Example 6, the subject matter of claim 5 can optionally include wherein receiving, from the wireless communication station, a confirmation of the session being established comprises receiving a ConfirmSessions( ) application programming interface (API) comprising parameters operating_class, channel_number, and MAC_address wherein the operating_class is the second frequency band, the channel_number is a channel within the second frequency band, and the MAC_address is a media access control (MAC) address associated with the second frequency band.

In Example 7, the subject matter of claim 1 can optionally include, once the session is established, transmitting the service data to and receiving the service data from the wireless communication station over the second frequency band.

In Example 8, the subject matter of claim 1 can optionally include transmitting, to the wireless communication station, one or more of events SessionRequest( ), ConnectStatus( ), SessionStatus( ), or PortStatus( ), wherein each event comprises at least parameters for operating_class, channel_number, and MAC_address wherein operating_class is the second frequency band, channel_number is a channel within the second frequency band, and MAC_address is a media access control (MAC) address associated with the second frequency band.

In Example 9, the subject matter of claim 1 can optionally include wherein transmitting the indication to the wireless communication station that service data during the session will be transmitted over the second frequency band comprises transmitting an application programming interface (API) that includes parameters for the second frequency band and a channel number associated with the second frequency band.

Example 10 is a method for managing a multi-band Wi-Fi Direct Services session that includes transmitting, over a first frequency band, a first application programming interface (API) to one or more wireless communication stations to negotiate the multi-band Wi-Fi Direct Services session, wherein the first API comprises operating_class, channel_number, and MAC_address parameters wherein operating_class is a second frequency hand, channel_number is a channel associated with the second frequency band, and MAC_address is a media access control (MAC) address associated with the second frequency band, receiving a second API from the one or more wireless communication stations indicating confirmation that the session is established, and transmitting service data to the one or more wireless communication stations over the second frequency hand when the session is established.

In Example 11, the subject matter of claim 10 can optionally include wherein transmitting, over the first frequency band, the first API to the one or more wireless communication stations comprises transmitting ConnectSessions(List of (service_mac, advertisement_id), session_information, network_role, operating_class, channel_number, MAC_address).

In Example 12, the subject matter of claim 10 can optionally include switching to a third frequency band during the session.

In Example 13, the subject matter of claim 12 can optionally include wherein switching to the third frequency band comprises switching to the third frequency band in response to channel conditions, a maximum tolerated error rate of the service data, and/or transmission speed desired for the service data.

Example 14 is a non-transitory computer-readable storage medium that stores instructions for execution by processing circuitry of a wireless communication station to manage a multi-band Wi-Fi Direct Services session, the operations to perform the session: transmit, over a first frequency band, a ConnectSessions( ) application programming interface (API) to a wireless communication station to negotiate the multi-band Wi-Fi Direct Services session, wherein the ConnectSessions( ) API comprises parameters for a second frequency band and a channel number associated with the second frequency band, receive a ConfirmSessions( ) API from the wireless communication station wherein the Confirm Sessions( ) API comprises the parameters for the second frequency and the channel number associated with the second frequency, and transmit service data to the wireless communication station over the second frequency band when the session is established.

In Example 15, the subject matter of claim 14 can optionally include wherein the operations to perform the session further: transmit GetSession( ), SetSessionReady( ), CloseSession( ), BoundPort( ), and ReleasePort( ) APIs to the wireless communication station, wherein each of the APIs includes parameters operating_class and channel_number.

In Example 16, the subject matter of claim 15 can optionally include wherein the operations to perform the session further: transmit events associated with the APIs, wherein each of the events includes the parameters for the second frequency band and the channel number associated with the second frequency band.

In Example 17, the subject matter of claim 15 can optionally include wherein the operations to perform the session further: transmit the GetSession( ), SetSessionReady( ), CloseSession( ), BoundPort( ), and ReleasePort( ) APIs to the wireless communication station, wherein each of the APIs includes a MAC_address parameter that is associated with the operating_class parameter.

In Example 18, the subject matter of claim 17 can optionally include wherein the operations to perform the session establishment further: transmit events associated with the APIs wherein each of the events includes the MAC_address parameter that is associated with the operating_class parameter.

In Example 19, the subject matter of claim 14 can optionally include wherein the operations to perform the session further: transmit an API to the wireless communication station including parameters for a third frequency band and a channel number associated with the third frequency.

In Example 20, the subject matter of claim 14 can optionally include wherein the operations to perform the session establishment further: transmit and receive service data with the wireless communication station over the third frequency band.

Example 21 is a wireless communication station that comprises: physical layer circuitry to transmit, over a first frequency band, a first application programming interface (API) to another wireless communication station to negotiate a multi-band Wi-Fi Direct Services session, wherein the first API comprises parameters for a second frequency band and a channel number associated with the second frequency band, the physical layer further to transmit service data to the other wireless communication station over the second frequency band after the session is established, and processing circuitry to control execution of services that generate the service data.

In Example 22, the subject matter of claim 21 can optionally include wherein the physical layer is further to receive a second API from the other wireless communication station indicating confirmation that the session is established.

In Example 23, the subject matter of claim 22 can optionally include wherein the physical layer is further to receive the second API comprising parameters for the second frequency band and the channel number associated with the second frequency band.

Example 24 is a method for operating a multi-band Wi-Fi Direct Services session that comprises receiving from a wireless communication station, over a first frequency band, an application programming interface (API) that includes parameters for a second frequency band and a channel number associated with the second frequency band, and communicating service data with the wireless communication station over the second frequency band after the multi-band Wi-Fi Direct Services session has been established.

In Example 22, the subject matter of claim 21 can optionally include transmitting a confirmation API to the wireless communication station, the confirmation API comprising the parameters for the second frequency band and the channel number associated with the second frequency band.

In Example 23, the subject matter of claim 21 can optionally include receiving one of a plurality of events that include SessionRequest( ), ConnectStatus( ), SessionStatus( ), or PortStatus( ), wherein each even comprises the parameters for the second frequency band and the channel number associated with the second frequency band.

Example 24 is a method for operating a multi-band Wi-Fi Direct Services session that comprises receiving, over a first frequency band, a ConnectSessions( )application programming interface (API) from a wireless communication station to negotiate the multi-band Wi-Fi Direct Services session, wherein the ConnectSessions( )API comprises operating_class, channel_number, and MAC_address parameters wherein operating_class is a second frequency band, channel_number is a channel associated with the second frequency band, and MAC_address is a media access control (MAC) address associated with the second frequency band, transmitting a ConfirmSessions( ) API to the wireless communication station indicating confirmation that the session is established, the Confirm Sessions( ) API comprising the operating_class, channel_number, and MAC_address parameters, and communicating service data with the wireless communication station over the second frequency band when the session is established.

Example 25 is a multi-band, wireless communication station configured to operate in a Wi-Fi Direct Services session that comprises means for transmitting, over a first frequency band, a first application programming interface (API) to one or more wireless communication stations to negotiate a multi-band Wi-Fi Direct Services session, wherein the first API comprises operating class, channel_number, and MAC_address parameters wherein operating_class is a second frequency band, channel_number is a channel associated with the second frequency band, and MAC_address is a media access control (MAC) address associated with the second frequency band, means for receiving a second API from the one or more wireless communication stations indicating confirmation that the session is established, and means for transmitting service data to the one or more wireless communication stations over the second frequency band when the session is established.

Example 26 is a multi-band, wireless communication station configured to operate in a Wi-Fi Direct Services session that comprises means for receiving from a wireless communication station, over a first frequency band, an application programming interface (API) that includes parameters for a second frequency band and a channel number associated with the second frequency band, and means for communicating service data with the wireless communication station over the second frequency band after the multi-band Direct Services session has been established.

Example 27 is a wireless communication station that comprises physical layer circuitry to transmit, over a first frequency band, a first application programming interface (API) to another wireless communication station to negotiate a multi-band Wi-Fi Direct Services session, wherein the first API comprises parameters for a second frequency band and a channel number associated with the second frequency band, the physical layer further to transmit service data to the other wireless communication station over the second frequency band after the session is established, and processing circuitry to control execution of services that generate the service data.

In Example 28, the subject matter of claim 27 can optionally include wherein the physical layer is further to receive a second API from the other wireless communication station indicating confirmation that the session is established.

In Example 29, the subject matter of claim 28 can optionally include wherein the physical layer is further to receive the second API comprising parameters for the second frequency band and the channel number associated with the second frequency band.

What is claimed is:

1. An apparatus of a wireless device configurable for peer-to-peer (P2P) communication with one or more other peer devices of a wireless local area network (WLAN), the apparatus comprising:
memory; and
a processor, configured to:
implement an application service platform (ASP) to coordinate discovery of services and manage sessions with the one or more other peer devices; and utilize the ASP to:
discover a service that is advertised by a peer device, the service being associated with an advertisement identifier (ID);
establish a P2P connection with the peer device by frame exchange, the ASP to indicate the advertisement ITS, an intended or current operating channel and supported channels, the processor to determine an agreed operating channel for the P2P connection based on the frame exchange;
set-up an ASP session with the peer device for the advertised service to utilize the established P2P connection, the ASP session being associated with a session ID; and
communicate session data associated with the service for the ASP session utilizing the session ID over the P2P connection with the peer device, the P2P connection utilizing the agreed operating channel.

2. The apparatus of claim 1 wherein the processor is further configured to utilize the ASP to receive an indication of a requested channel from the peer device for the P2P connection as part of the frame exchange.

3. The apparatus of claim 1 wherein the ASP session is a first ASP session, and wherein the processor is further configured to utilize the ASP to set up a second ASP session with the peer device for a second advertised service, the second ASP session being concurrent with the first ASP session.

4. The apparatus of claim 3 wherein for the second ASP session, the processor is further configured to utilize the ASP to communicate session data over the P2P connection using a session ID for the second session.

5. The apparatus of claim 1, wherein the processor is further configured to utilize the ASP to determine the agreed operating channel that is different than a channel used for the ASP session set up.

6. The apparatus of claim 1 wherein the ASP is a logical entity implemented by the processor.

7. The apparatus of claim 1 wherein the service comprises at least one of send, play, display or print.

8. The apparatus of claim 1, wherein the processor is further configured to utilize the ASP to:
advertise services; and
respond to an incoming request from a peer device to establish an ASP session for the advertised services.

9. The apparatus of claim 1 wherein the apparatus s configurable for multi-channel operation, and
wherein the processor is further configured to utilize the ASP to set up the ASP session utilizing a first channel, and switch to a second channel for communication of the session data, the second channel being the agreed operating channel.

10. The apparatus of claim 1 wherein the processor is further configured to implement an application programming interface (API) protocol to allow an application to access the ASP session for the service, and
wherein the processor is configured to utilize the ASP to communicate the session data associated with the service for the ASP session utilizing the session ID over the P2P connection with the peer device in accordance with the API protocol.

11. An apparatus of a wireless device configurable for peer-to-peer (P2P) communication with one or more other peer devices of a wireless local area network (WLAN), the apparatus comprising:
memory; and
a processor, configured to:
send a discovery request frame to discover a service that is advertised by a peer device, the service being associated with an advertisement identifier (ID) that is received in a discovery response frame;
send a provision discovery request frame and receive a provision discovery response frame to establish a P2P connection with the peer device, the provision discovery request frame and the provision discovery response frame comprising a frame exchange, the provision discovery request frame encoded to indicate the advertisement ID, an intended or current operating channel and supported channels, the processor to determine an agreed operating channel for the P2P connection based on the frame exchange;
set-up an application service platform (ASP) session with the peer device for the advertised service to utilize the established P2P connection, the ASP session being associated with a session ID; and
send session data associated with the service for the ASP session utilizing the session ID over the P2P connection with the peer device, the P2P connection utilizing the agreed operating channel.

12. The apparatus of claim 11 wherein the processor is further configured to:
implement an ASP to coordinate discovery of services and manage sessions with the peer device; and
utilize the ASP to:
discover the service that is advertised by the peer device;
set-up the ASP session with the peer device; and
communicate the session data to the peer device.

13. The apparatus of claim 12 the processor is further configured to utilize the ASP to receive an indication of a requested channel from the peer device for the P2P connection as part of the frame exchange.

14. The apparatus of claim 12 wherein the ASP session is a first ASP session, and wherein the processor is further configured to utilize the ASP to set up a second ASP session with the peer device for a second advertised service, the second ASP session being concurrent with the first ASP session.

15. The apparatus of claim 14 wherein for the second ASP session, the processor is further configured to utilize the ASP to communicate session data over the P2P connection using a session ID for the second session.

16. The apparatus of claim 12, wherein the processor is further configured to utilize the ASP to determine the agreed operating channel that is different than a channel used for the ASP session set up.

17. A non-transitory computer-readable storage medium that stores instructions for execution by one or more processors of a wireless device configurable for peer-to-peer (P2P) communication with one or more other peer devices of a wireless local area network (WLAN), the instructions to configure the one or more processors to:
implement an application service platform (ASP) to coordinate discovery of services and manage sessions with the one or more other peer devices; and utilize the ASP to:
discover a service that is advertised by a peer device, the service being associated with an advertisement identifier (ID);
establish a P2P connection with the peer device by frame exchange, the ASP to indicate the advertisement ID, an intended or current operating channel and supported channels, the processor to determine an agreed operating channel for the P2P connection based on the frame exchange;
set-up an ASP session with the peer device for the advertised service to utilize the established P2P connection, the ASP session being associated with a session ID; and
communicate session data associated with the service for the ASP session utilizing the session ID over the P2P connection with the peer device, the P2P connection utilizing the agreed operating channel.

18. The computer-readable storage medium of claim 17 wherein the processor is further configured to utilize the ASP to receive an indication of a requested channel from the peer device for the P2P connection as part of the frame exchange.

19. The computer-readable storage medium of claim 17, wherein the processor is further configured to utilize the ASP to determine the agreed operating channel that is different than a channel used for the ASP session set up.

20. A method for peer-to-peer (P2P) communication with one or more other peer devices of a wireless local area network (WLAN), the method comprising:
implementing an application service platform (ASP) to coordinate discovery of services and manage sessions with the one or more other peer devices; and utilizing the ASP to:
discover a service that is advertised by a peer device, the service being associated with an advertisement identifier (ID);
establish a P2P connection with the peer device by frame exchange, the ASP to indicate the advertisement ID, an intended or current operating channel and supported channels, the processor to determine an agreed operating channel for the P2P connection based on the frame exchange;
set-up an ASP session with the peer device for the advertised service to utilize the established P2P connection, the ASP session being associated with a session ID; and
communicate session data associated with the service for the ASP session utilizing the session ID over the P2P connection with the peer device, the P2P connection utilizing the agreed operating channel.

21. The method of claim 20 further comprising utilizing the ASP to receive an indication of a requested channel from the peer device for the P2P connection as part of the frame exchange.

22. The method of claim 20 wherein the ASP session is a first ASP session, and wherein the method further comprises utilizing the ASP to set up a second ASP session with the peer device for a second advertised service, the second ASP session being concurrent with the first ASP session.
